(19) United States
(12) Patent Application Publication
(10) Pub. No.: US 2006/0010221 A1
(43) Pub. Date: Jan. 12, 2006

(54) Sharing information from a computer mail-box

(76) Inventor: Arvind Srinivasan, Santa Clara, CA (US)

Correspondence Address: THEODORE JAY, SUITE 600, 16 N. CHATSWORTH AVE, LARCHMONT, NY, 10538, US

(21) Appl. No.: 11/197,028

(22) Filed: Aug. 4, 2005

Related U.S. Application Data
(63) Continuation-in-part of application No. 09/898,159, filed on Jul. 3, 2001.
(60) Provisional application No. 60/288,639, filed on May 4, 2001.

(51) Int. Cl. G06F 15/16

(52) U.S. Cl. 709/206

(57) ABSTRACT

A method for an owner to own and use a computer mail-box in storing and selectively transmitting mails from a user, who may or may not be an originating user, to a destination user. The method includes using the mail-box as a functional interface that enables mails to be displayed, sorted, altered, rearranged, deleted and catalogued therein; storing the mails in folders; identifying certain specific folders as Inbox, Send Items and Trash; and sharing by the owner messages, folders, portions of the mail-box or even the entire mail-box with specific other users.

### CROSS REFERENCE TO PENDING APPLICATION

The present invention is a continuation in part of co-pending application of Arvind Srinivasan entitled Sharing Information From A Computer Mail-Box Ser. No. 09/898,159 having a filing date of Jun. 3, 2001. This co-pending application in turn is a continuation in part of provisional application of Arvind Srinivasan entitled Sharing Information From A Mail-Box Ser. No. 60/288,639 having a filing date of May 4, 2001.

### BACKGROUND OF THE INVENTION

A computer mail-box is defined as a private virtual storage space in a computer which is controlled by an owner for the purpose of storing and selectively transmitting mails from a user, who may or not be an originating user, to a destination user. A mail is any information, thought or idea expressed in plain or encrypted computer format for storage and/or transmission. An originating user is a user initiating a mail transfer and a destination user is the one for whom the mail is intended. The originating user can also be the destination user. The owner and all users have email access via computer. Only the owner has the authority to define and authorize email access rights of users to the entire mail-box.

A mail-box provides a functional interface that enables mails to be displayed, sorted, altered, rearranged, deleted and catalogued. Users authorized by the owner can receive and respond to such mails. The mails are usually stored in folders. Folders are normally user defined except for certain folders specifically defined as Inbox, Send Items and Trash respectively. Inbox folders normally consist of mails received by the user. The folders in Sent Items normally comprise mails sent by the mail-box user to other users. Trash folders contain mails that have been deleted by a mail-box user.

The mails in each of these folders can be sorted, deleted or rearranged into other folders depending upon the user's desire. These mails may be sorted based on various criteria including but not limited to the originating user, date or the subject of the mail

Mailboxes are typically setup on a mail server, which holds mail information for all users on that server. A mail client typically connects to the mail server and retrieves the information held on that server. Mail clients connect to the server via one or more of the the following protocols: SMTP, POP, IMAP, HTTP, WEB-DAV, WAP or more proprietary like MAPI, native domino API, DIIOP etc. Mail users typically view, initiate mails and manage their mailbox from a mail client.

### SUMMARY OF THE INVENTION

In accordance with the principles of this invention, the owner can share messages, folders, or a portion of the mailbox or the entire mailbox with other specific users. The owner has the authority to determine privileges and access rights to his entire mailbox or parts therein. The owner also has access to information on parties accessing his mail-box.

This invention is designed to enable owners to share their mailbox with other users. At a minimum, the user with whom the mailbox will be shared requires an email address and browser access to the internet. The users with whom the mailbox is shared does not require a full user account or a corporate credential on the mail system. One of the big differences between this method and that of the Delegate feature available in existing mail system such as MS Exchange and Lotus Notes is that a Delegated user needs to be an existing user on the mail system and must have access to the company networks. It is designed for trusted users such as secretary or assistant to enable mail activity. With the current invention, the end user can be anyone on the internet with an email address and a browser access. This enables one to share parts of their mailbox with practically anyone. Also, this invention is very different from having a group mailbox. Unlike group mailboxes, the user owns their own mailbox where one receives their personal and business communication can be shared.

In order for the owner to share his messages with other users, he becomes an originating user and has a list of all potential users and can share messages/folders with the selected user or users. He specifies the user with whom he wishes to share his message/folder. He can enter the email address of the selected user if it is not known to the system or enter the nickname of the user if the user is listed in his address book. He can specify the permission or permissions he grants to the user in his sharing action. He can give the user or users authority to read, respond or receive complete control over the message/folder and can limit this authority for a specified limited time period.

If the owner wishes to grant access to a group of selected users or to an entire domain he may do so for a limited or unlimited period. The owner then starts the sharing software which then arranges for a URL [universal resource indicator] to be created and mailed to each of the selected users specified. Each recipient can then click on the URL to obtain the desired access or can store it for future use.

In this manner, the owner can share his messages, folders or his entire mail-box with various other parties for specific durations with specified privileges. This arrangement enhances the ability to share information and increases collaboration at both a personal lever as well as at a corporate level ensuring optimum security.

The invention will now be explained in more detail with reference to the drawings and detailed description which follow

### BRIEF DESCRIPTION OF THE DRAWINGS

FIG. 1 illustrates Ziplip's email sending/receiving architecture.

FIG. 2 illustrates the creation of a mail-box

FIG. 3 illustrates a mailbox owned by John Doe

FIG. 4 illustrates the sharing action of John Doe's selected folders with selected users

FIG. 5 illustrates the sending of a URL to selected users after John Doe has initiated the sharing software.

FIG. 6 illustrates the sharing of these message folders with other parties.

FIG. 7 illustrates the access to the owner's mailbox.

FIG. 8 illustrates the entire flow chart.

### DETAILED DESCRIPTION OF PREFERRED EMBODIMENTS

In a typical mail system, a typical user has one or more email accounts with each account represented by a unique email address. This account is created by the administrator or using a self registration mechanism. Once the account is created, the mail system accepts incoming mail for this user from other users within the internal and the external network. The accepted mail is typically stored inside the designated user mailbox.

The mail system also accepts outgoing mail from this users and delivers them to other users on the internal and external network. The mail system has the ability to save a copy of the delivered mail in the sent items folder. Users access and manage their mails using either a standard IMAP client or one of the many proprietary clients provided by the mail suite. The proprietary client may include a web-access to enable remote access. The mail store provides capabilities to organize mails in folders. In any mail system, there are standard folders such as INBOX, SENT ITEMS, Trash et al and these folders have semantic rules, such as all new mails go to the INBOX by default, etc. The owner of the mailbox can create additional folders both as a flat structure or as an hierarchical structure. Users can move mails between these folders to organize the folders. User mail operation may include creating, renaming and deleting folders; reading, moving between folders, deleting mails.

Each organization has a set of internal networks and the network connectivity between the internal and external networks are controlled by firewalls, proxy servers, etc. The user must have access to the internal network and must authenticate before access to the mailbox is granted.

Traditionally, mailbox operations were performed by the owner. More recently, Mailbox delegate functionalities have appeared to enable other person such as an assistant or a peer to perform mailbox operation on behalf of the users. Further, such delegation activities are performed by other full users of mail system. The granularity of control is typically limited.

This application enables a owner of mailbox to share, collaborate and delegate actions with any one on the internet who has an email address. This action can be initiated by the owner without the aid of an administrator in an ad-hoc fashion. Examples of such a method will enable one to share a set of emails with several individuals concurrently on the internet without really forwarding the data. Another, example is to enable management of email including organizing them in folders and deleting the same.

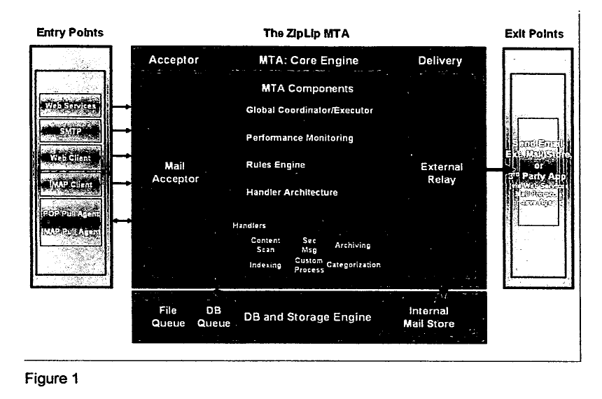

FIG. 1 shows the general architecture of ZipLip mail server. The components include the mail entry points module. This module is responsible for accepting mail using various protocols, API's, etc. The mail entry points include mails coming from other SMTP servers, both external and internal, Web Clients, Proprietary clients, API based deliveries and other agents that go to other mail server and fetch mails. The mails are submitted to the Mail Transfer Agent (MTA). The MTA looks at each mail and processes them accordingly, storing the mail in the Internal Mail store for all incoming mails that it manages. Otherwise the MTA sends it via relay to other exit servers. The exit point includes sending mails to other SMTP servers, other proprietary mail servers and mail stores. The MTA is designed to scale and handle large volumes of mails.

A user is given an email account either by the administrator or they have the ability to register themselves. With the account, the user will have an email address and mailbox to which all incoming and outgoing mails are store. At the time of creation, the system automatically provides the user with a certain amount of virtual private space to store his messages. The system also creates four standard folders, namely Inbox, Sent, Drafts and Trash and the mailbox formation is complete. The user may take various steps such as customizing the account, change various particulars, create new folders, and the like.

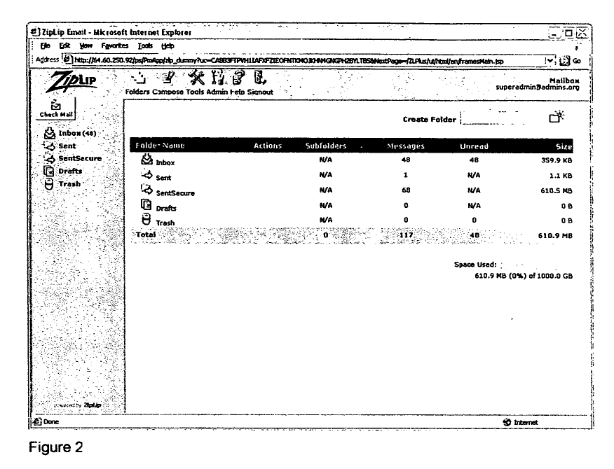

FIG. 2 illustrates a typical mailbox as seen by the owner using a web-client.

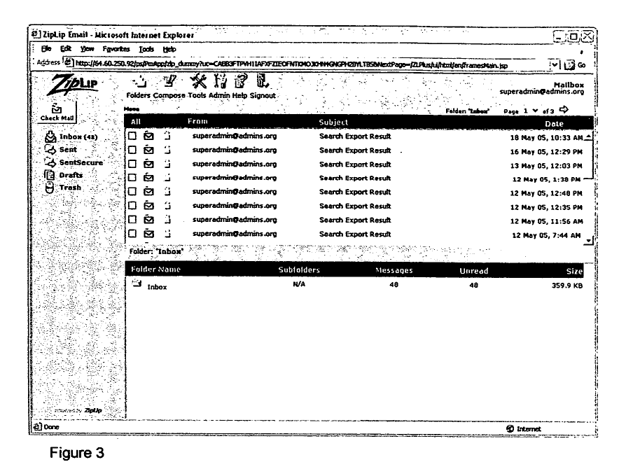

FIG. 3, shows an inbox having several messages and how an user can browse through and read the mails.

The sharing software presents the user with the unique opportunity to share messages, folders or the entire mail-box with other users. The user clicks on the appropriate message/folder and starts the sharing software. To do so, the user clicks on the selected message/folder and selects sharing as an option.

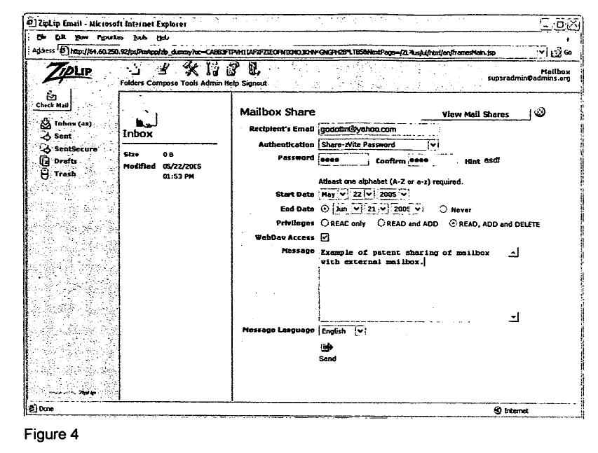

FIG. 4 illustrates the different sharing options that the software provides. The user specifies the user[s] he wishes to share the selected message/folder with. To do so, the user may enter the email address of the user, or the name if the user exists in his address book. The user may choose an entire domain if he so wishes. The owner also specifies the duration for which this permission is granted. The user then creates a password for this message/folder.

The owner then specifies the permissions he would like to grant other parties. He could give the parties authority to read, write or grant complete control over the message/folder. The owner may also want to conduct audit trails to track information regarding the time and duration of user access.

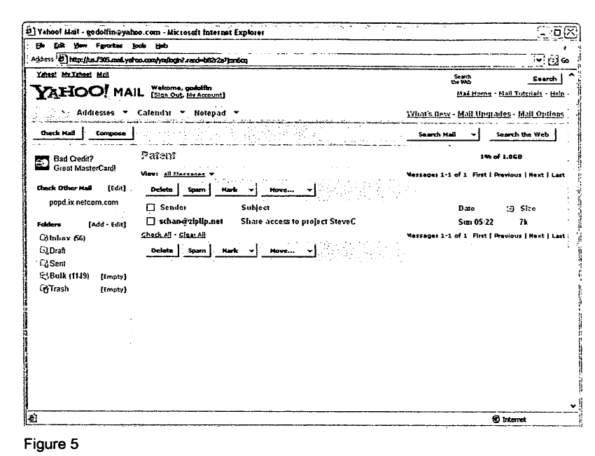

Once the sharing software is activated, the system generates a URL and sends it to all the concerned parties informing them of their access rights. FIG. 5 illustrates the URL that the system sends to all the parties. The URL provides the exact location where the message/folders are located. Other parties may enter the appropriate password and access the message/folder immediately or they may save the URL for later access.

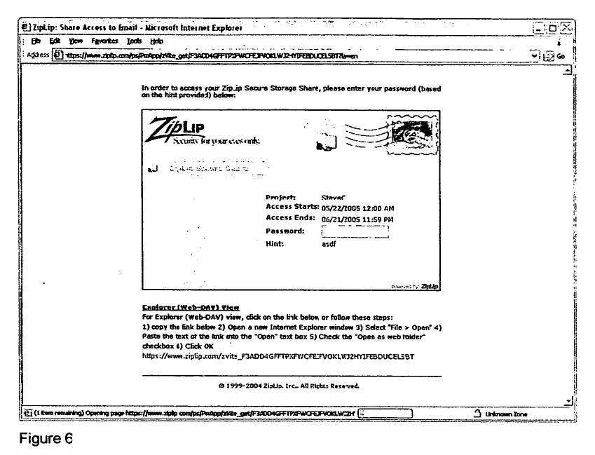

FIG. 6 illustrates the sharing of these message folders with other parties.

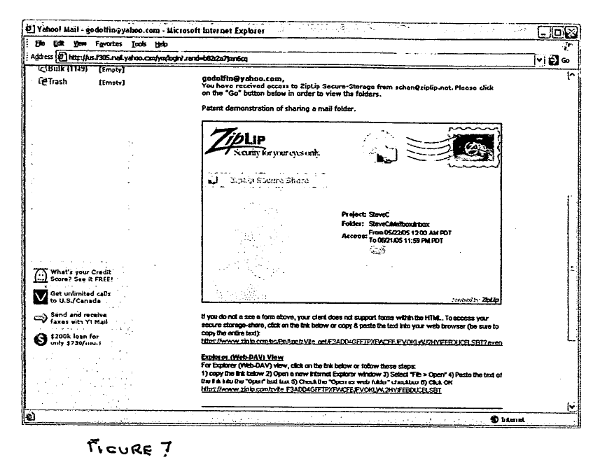

FIG. 7 illustrates the access to the owner's mailbox.

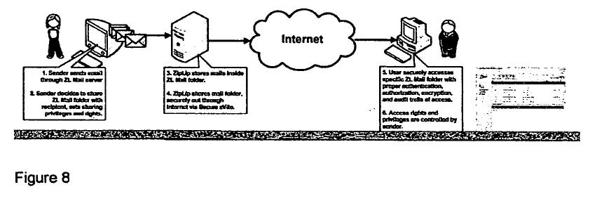

FIG. 8 illustrates the entire flow chart.

Once other parties access the message/folder, users may track the time and duration of this access at any time.

The same approach is also used to share a single message, delegate other mail functionalities. It should be noted that the proposed method provides an adhoc method to share, collaborate and delegate mailbox functionalities with any user on the internet having an email address.

While the invention has been described with particular reference to the drawings and detailed description, the protection solicited is to be limited only by the terms of the claims which follow.

What is claimed is:

1. A method for the owner of mailbox to share parts of the mailbox with any one on the internet with the only requirement of having an email address and browser access wherein the sharer uses the browser to connect to the ZipLip server software to get the required access.

2. Method as set forth in claim 1, wherein, the sharing includes prescribing rights to specific folders, and/or their subfolder(s), and/or specific messages and limits the duration of access and sharing as initiated by the end user and no administrator is required.

3. Method in as set forth in claim 2 where the user can prescribe the rights from a single screen UI.

4. Method as set forth in claim 3 wherein the end user receives information about access via a standard email with all the required information about the access and privileges, and the end user for reception only requires a browser access via regular HTTP or SSL based HTTP.

5. Method as set forth in claim 4 wherein the user with whom the mail is shared uses the method of claim 4 to organize mails, read mails and transmit new mails, based on the given privilege.

6. Method as set forth in claim 5 wherein actions of the users are audited and presented to owner enabling the owner to have full knowledge of what share activity takes place on his/her mailbox and wherein the sharer has the ability to revoke access at any time.
